(19) United States
(12) Patent Application Publication
(10) Pub. No.: US 2008/0220128 A1
(43) Pub. Date: Sep. 11, 2008

(54) Food Casing Based on Cellulose Hydrate with a Coating Containing Collagen Fibrils and Gelatin

(76) Inventors: Klaus-Dieter Hammer, Mainz (DE); Herbert Gord, Ingelheim (DE); Gerhard Grolig, Moerfelden-Walldorf (DE); Walter Lutz, Budenheim (DE)

Correspondence Address: PROPAT, L.L.C., 425-C SOUTH SHARON AMITY ROAD, CHARLOTTE, NC, 28211-2841, US

(21) Appl. No.: 11/994,860

(22) PCT Filed: Jul. 5, 2006
(86) PCT No.: PCT/EP06/06547

§ 371 Date: Jan. 7, 2008

(30) Foreign Application Priority Data
Jul. 9, 2005 (DE) 10 2005 032 241.7

(51) Int. Cl. A23L 1/05; A23L 1/31; A23L 1/317; A23L 1/0562; A23L 1/0534; A23L 1/00

(52) U.S. Cl. 426/92; 426/89; 426/305; 426/103

(57) ABSTRACT

Disclosed is a preferably tubular food casing based on cellulose hydrate, one or both sides of which is/are provided with a coating containing crosslinked collagen fibrils and an also crosslinked, high-molecular gelatin. Preferably, low-molecular organic compounds comprising two or more reactive groups are used as crosslinking agents. The inventive food casing has characteristics resembling those of a skin fiber casing and is thus particularly suitable for producing raw sausages. The disclosed casing is virtually resistant against cellulytically active enzymes of mold-ripened raw sausages as a result of the coating used.

The invention relates to a food casing coated on one and/or both sides and based on cellulose hydrate, to a process for its production, and also to its use as synthetic sausage casing.

Hide fiber skins are composed of cured collagen. They have particularly good suitability as a casing for long-life sausage, such as salami. The long-life sausage can ripen ideally in this type of casing. At the same time, the casing has good adhesion to the emulsion of the long-life sausage. In the case of long-life sausage types which are ripened using edible mold, the mold bonds firmly to the casing. The casing is moreover resistant to cellulytic enzymes (cellulases), which can be formed from the mold under disadvantageous ripening conditions. However, production of hide fiber skins is very complicated and correspondingly expensive. The starting material used comprises the “hide offcuts” arising during leather production from cow hide. These are subjected to acid digestion and comminuted until the hide fiber fibril stage has been reached. The fibrils can be up to about 30 μm thick and up to about 40 mm long. The fibril-fiber emulsion formed from these is then extruded and hardened, for example via treatment with NH₃. A disadvantage of hide fiber skins is their relatively low mechanical strength. They easily rupture during stuffing with the sausage emulsion. Another factor is that the diameter of hide fiber skins cannot always be kept constant (inconstant caliber). Finally, the positioning of the clips used to seal the stuffed sausage casings is not very secure.

In contrast to this, cellulose fiber skins exhibit very good mechanical properties, but are attacked by cellulases. Various coatings have been developed to increase cellulase resistance. However, cellulose fiber skins provided with a coating composed of polymers based on hydrophilic vinyl monomers (DE-A 32 27 920) are practically resistant to cellulase attack. Alongside this, a coating has been proposed based on casein, crosslinked with glyoxal (DE 36 06 195). There are also known cellulose fiber skins with a coating on the outer side which encompasses a cationic resin insoluble in water and also encompasses particles or fibers composed of plastic or cellulose (DE-A 37 13 712). Cellulose fiber skins which comprise, mixed with the cellulose hydrate, vinylpyrrolidone homo- or copolymers likewise exhibit reduced susceptibility to cellulytic enzymes (DE-A 102 51 200). Cellulose fiber skins are also inferior to hide fiber skins in ripening behavior. In comparison with hide fiber skins, they have much higher permeation values. Cellulose hydrate fiber skins likewise have no particularly good suitability for mold ripening.

There was therefore an ongoing object of developing a casing which is particularly suitable for long-life sausage and which combines the advantages of hide fiber skins with those of cellulose fiber skins, but avoids the disadvantages. In particular, the casing is intended to be resistant to cellulytic enzymes which can be produced from molds during the production of mold-ripened long-life sausages. It is moreover intended to have constant caliber. Plastics clips or metal clips used for the sealing process are intended to have secure grip and not to slide off. The casing is moreover intended to have maximum ease of production.

The object was achieved using a coating which contains collagen fibrils, and preferably also at least one high-molecular-weight gelatin, where these two are crosslinked.

The present invention accordingly provides a food casing coated on one and/or both sides and based on cellulose hydrate, wherein the coating encompasses crosslinked collagen fibrils and at least one crosslinked, high-molecular-weight gelatin. The high-molecular-weight gelatin has, prior to crosslinking, a Bloom number less than 320, particularly preferably from 260 to 310.

The food casing preferably has fiber reinforcement, which in particular is composed of a fiber paper with wet strength, for example a hemp fiber paper bonded with viscose and/or with a synthetic resin. The weight of the fiber reinforcement is generally from 15 to 28 g/m², preferably from 17 to 25 g/m².

If the food casing is intended to be a synthetic sausage casing, it is then advantageously tubular. During production of a fiber-reinforced sausage casing, the fiber reinforcement here is first shaped to give a tube with overlapping longitudinal edges, and this is then coated on the inside and/or outside with the aid of an annular die for example with viscose or with cellulose dissolved in aqueous N-methylmorpholine N-oxide (NMMO). After regeneration or precipitation of the cellulose, this method gives a casing which appears practically seamless. To modify the properties of the casing, additives can be added to the viscose or the NMMO/cellulose solution. Examples of these are alginic acid and/or alginates, fatty amines, fatty alcohols or their ethoxylates, fatty acid salts, copolymers having vinylpyrrolidone units and alkyl (meth)acrylate units, where the alkyl moiety has primary, secondary, or tertiary amino groups, or trialkylammonium groups (EP-A 0 638 241). Copolymers having units of vinylpyrrolidone and of ethyl (2-methacryloyloxyethyl)-dimethylanmoniumethyl sulfate are available by way of example as ®Gafquat 755 N. These additives can reduce the permeation value of the casings, making them more similar to hide fiber skins. Many of the additives mentioned moreover act as permanently plasticizing, non-leachable plasticizers (“primary plasticizers”).

In order to crosslink the collagen fibrils and the water-soluble gelatin, it is advantageous to use low-molecular-weight, organic compounds having two or more reactive groups. The selection of the groups should be such that the reaction produces covalent bonds between the collagen fibrils, between the collagen fibrils and the gelatin, and also between the collagen fibrils or the gelatin and the regenerated cellulose. Preferred crosslinking agents of this type are dialdehydes, in particular glyoxal, glutaraldehyde, succinaldehyde, sugar dialdehydes, epoxidized linseed oil (which at the same time exhibit plasticizing action), dialkyl ketenes (available by way of example as ®Aquapel), citral, or tannin. The gelatin can also be crosslinked using transglutaminases. In principle, the crosslinking can also be achieved by other methods, for example via treatment with high-energy radiation.

In one preferred embodiment, the ratio by weight of high-molecular-weight gelatin to the collagen fibrils is front 90:10 to 30:80. A ratio of about 80:20 is preferred.

It is preferable that the proportion of crosslinking agent(s) is from 2 to 20% by weight, preferably from 3 to 16% by weight, particularly preferably from 5 to 10% by weight, based in each case on the total weight of collagen fibrils and gelatin. Particular preference is given to the combination of about 5 to 7% by weight of glyoxal and from 3 to 5% by weight of epoxidized linseed oil.

The inventive food casing has, on one side or on both sides, a layer which contains crosslinked collagen fibrils.

The weight of a coating located on the side facing toward the food is advantageously from 80 to 200 mg/m². In specific embodiments, the coating weight can also be from 1000 to 20 000 mg/m², preferably from 1000 to 5000 mg/m², corresponding to a layer thickness of from 1 to 20 μm, preferably from 1 to 5 μm. Affinity with respect to the emulsion here can be varied by changing the ratio of collagen fibrils to gelatin. As fibril content increases, the inner surface becomes rougher, and this likewise influences the adhesion of the casing to the emulsion. The inventive casing has a particularly high affinity with respect to the emulsion that is desirable for long-life types of sausage. The coating weight of a layer located on the side facing away from the food is advantageously from 80 to 20 000 mg/m² preferably from 150 to 7000 mg/m², particularly preferably from 250 to 5000 mg/m². In these relatively thick outer layers, the ratio by weight of gelatin to fibrils is advantageously in the range from 60:40 to 50:50. The hide fiber skin character on the outer side can likewise be controlled via specific adjustment of the ratio of fibrils to gelatin, and also via the layer thickness. As the thickness of the outer coating increases, it should be more conformable and have better crosslinking. As the thickness of the layer located on the outer side increases, cellulase resistance increases, and at the same time permeation value decreases. As layer thickness rises, permeation value approaches that of hide fiber skins. The permeation value of these is from 10 to 12 l/m² at 40 bar. Casings with a thick outer layer have particularly good suitability as synthetic sausage casings for mold-ripened long-life sausage. When the inventive casing is used, practically no undesired dry edges then occur during ripening of the sausage.

In particular in the case of relatively thick coatings, it has proven advantageous to blend the fibrils/gelatin mass with plasticizing synthetic polymer dispersions, for example with an acrylate polymer (for example butyl acrylate polymer dispersion), synthetic rubber dispersion, or a polystyrene dispersion. The synthetic polymer dispersions give the casing better conform-ability, and also reduce the overall solubility of the coating. The proportion of these polymers is generally about 20 to 60% by weight, preferably about 30 to 50% by weight, based on the total weight of gelatin and fibrils.

The inventive food casing can also comprise a leachable (“secondary”) plasticizer, preferably glycerol.

The inventive food casing combines the advantageous properties of a cellulose fiber skin (in particular its high strength) with the advantages of a hide fiber skin (in particular low permeability). Casings for a very wide variety of foods can be provided via appropriate selection of the ratio of gelatin to collagen fibrils and of the layer thickness.

The present invention also provides a process for the production of the food casing. In the process, an aqueous composition is used to coat a casing which is based on cellulose hydrate and which is still in the gel state, where the aqueous composition comprises collagen fibrils and at least one high-molecular-weight gelatin, and the casing is then dried. The composition also preferably comprises at least one crosslinking agent, preferably glyoxal. Prior to the coating process, the casing can pass through a bath which comprises a secondary plasticizer, preferably glycerol. The casing, generally tubular, is advantageously coated in the collapsed state. Devices known per se to the person skilled in the art are used to apply the mixture encompassing collagen fibrils and encompassing gelatin, for example by doctor application. The crosslinking generally occurs during the drying process.

The inventive food casing is in particular used as synthetic sausage casing, preferably for raw sausage, and also for scalded-emulsion sausage. The properties of the coated surface here are practically the same as those of a hide fiber skin. The inventive casing can be used particularly advantageously for mold-ripened raw sausage. Under disadvantageous ripening conditions, the edible mold used here produces cellulytic enzymes (cellulases). In uncoated casings, the cellulases can degrade the regenerated cellulose. This can extend to substantial destruction of the casing, where the residues of the casing are then difficult to remove from the sausage emulsion. Surprisingly, coating with the collagen fibrils completely eliminates this effect. The coating also reduces the water-permeability of the food casings, i.e. the permeation value. The high adhesion of the inventive casing to emulsion permits slicing of a scalded-emulsion sausage without any resultant displacement of the casing residues adhering on the periphery of the individual slices.

The examples below serve for illustration of the invention. Percentages in the examples are percentages by weight unless otherwise stated or otherwise apparent from the context. pw stands for part(s) by weight. Caliber indicates the internal diameter of the tubular casing in millimeters.

### EXAMPLE 1

A 60-caliber double-viscosed cellulose gel skin with internal reinforcement composed of a hemp fiber paper bonded to give wet strength (viscose distribution: 40% outside, 60% inside) was passed, after leaving the glycerol vat, through a roller-application unit, which applied an aqueous dispersion to the outer side. The dispersion comprised 3% of a mixture composed of
80 pw of gelatin (Bloom number 280),
20 pw of collagen fibrils, and
5 pw of glyoxal as crosslinking agent.

The same dispersion was introduced into the interior of the gel tube before this passed into the dryer, in order to coat the inner surface (“slug coating”). The tube was then conventionally dried using hot air in the expanded state between two pairs of squeeze rolls, and wound up. The weight of the crosslinked gelatin/fibrils layer on the inner side was 100 mg/m², and on the outer side was 160 mg/m².

The tube was then shirred, stuffed with long-life sausage emulsion, and mold-ripened for a number of months. Mold growth was uniform and firm. After ripening, the casing continued to adhere firmly to the surface of the emulsion. The cellulose content of the casing exhibited no degradation that could be attributed to cellulytic enzymes (cellulases), despite the long ripening time. Peelability of the casing after ripening was assessed as “3” (scale from 1 to 5, where 1 means extremely good peelability and 5 means that it has become impossible to peel the casing without damaging it irreversibly).

### EXAMPLE 2

A 60-caliber cellulose hydrate gel skin with internal reinforcement composed of a hemp fiber paper bonded to give wet strength and which has been modified by content of alginate and calcium stearate, and which was therefore permanently plasticized (as disclosed in example 1 of EP-A 0 638 241), therefore requiring no glycerol, was coated on the outer side with a 50% strength aqueous dispersion, with the aid of a roller-application unit. The non-aqueous content of the dispersion was composed of
60 pw of gelatin (Bloom number 280),
40 pw of collagen fibrils,
5 pw of glyoxal, and
8 pw of epoxidized linseed oil.

The application unit had been adjusted so that the thickness of the collagen-containing coating after drying was 5 μm. The tube was then conventionally dried using hot air in the expanded state between two pairs of squeeze rolls. Crosslinking of the collagen-containing layer took place here, and the layer bonded firmly to the cellulose hydrate surface.

The fiber skins thus produced exhibited a permeation value of 25 l/m²·d at a pressure of 40 bar. The skins were stuffed with long-life sausage emulsion and mold-ripened. The mold grew slowly and formed a thin and uniform mold coating which adhered very firmly. In no case was any degradation of the cellulose hydrate material caused by cellulases observed, even under disadvantageous ripening conditions. The surface properties of the casing were therefore substantially identical to those of a hide fiber skin.

### EXAMPLE 3

A cellulose hydrate gel skin with internal reinforcement composed of a hemp fiber paper bonded to give wet strength, with a reduced amount of viscose as in DE-A 195 10 883, was coated, after leaving the glycerol vat, in the collapsed state, with a 20% strength aqueous dispersion, with the aid of a doctor. The non-aqueous content was composed of
50 pw of gelatin,
50 pw of collagen fibrils,
5 pw of glyoxal as crosslinking agent,
10 pw of epoxidized linseed oil (®Edenol), and
30 pw of dispersed acrylate (using an aqueous acrylate dispersion).

The amount of this mixture applied by the doctor was such as to give, after drying, a coating of thickness 20 μm.

The permeation value of the sausage casing thus produced was 18 l/m²·d at 40 bar. The permeation value had therefore been markedly reduced in comparison with that of an uncoated casing.

The casing was, as described in examples 1 and 2, stuffed with long-life sausage emulsion, and mold-ripened. Ripening proceeded very well, and mold growth and cellulase resistance were very good. No dried edge formed, even under disadvantageous ripening conditions.

1. A food casing comprising a coating disposed on one or both sides of said casing, said coating comprising and cellulose hydrate, wherein the coating further comprises crosslinked collagen fibrils and at least one crosslinked, high-molecular-weight gelatin.

2. The food casing as claimed in claim 1, wherein the at least one high-molecular-weight gelatin has, prior to crosslinking, a Bloom number from 260 to 320.

3. The food casing as claimed in claim 1, wherein the coating comprises at least one crosslinking agent.

4. The food casing as claimed in claim 1, which said food casing further comprising fiber reinforcement.

5. The food casing as claimed in claim 1, wherein said food casing is tubular.

6. The food casing as claimed in claim 3, wherein the crosslinking agent is a dialdehyde.

7. The food casing as claimed in claim 1, wherein the ratio by weight of high-molecular-weight gelatin to the collagen fibrils is from 90:10 to 30:80.

8. The food casing as claimed in claim 3, wherein the proportion of crosslinking agent(s) is from 2 to 20% by weight, based on the total weight of collagen fibrils and gelatin.

9. The food casing as claimed in claim 1, wherein the side facing toward the food has been coated and has a coating weight of from 80 to 200 mg/m².

10. The food casing as claimed in claim 1, wherein the side facing away from the food has been coated, and has a coating weight of from 80 to 20 000 mg/m².

11. The food casing as claimed in claim 10, wherein the coating has been blended with a plasticizing synthetic polymer dispersion.

12. The food casing as claimed in claim 1, which comprises a secondary plasticizer.

13. A process for the production of a food casing as claimed in claim 1 comprising coating a casing based on cellulose hydrate which is in the gel state with an aqueous composition comprising collagen fibrils, crosslinking the collagen fibrils with one another and with the cellulose hydrate, and drying the casing.

14. The process as claimed in claim 13, said process further comprising adding at least one high-molecular-weight gelatin to the aqueous composition.

15. The process as claimed in claim 13, said process further comprising passing the casing, prior to the coating process, through a bath which comprises a secondary plasticizer.

16. The process as claimed in claim 13, wherein the casing is tubular and is coated in the collapsed state.

17. The process as claimed in claim 14, wherein the aqueous composition comprising collagen fibrils and gelatin is applied during said coating process by doctor-application.

18. Synthetic sausage casing comprising food casing as claimed in claim 1.

19. The food casing as claimed iii claim 4, wherein the fiber reinforcement comprises a fiber paper with wet strength.

20. The food casing as claimed in claim 4, wherein the fiber reinforcement is a hemp fiber paper.

21. The food casing as claimed in claim 6, wherein the crosslinking agent is glyoxal, glutaraldehyde, succinaldehyde, a sugar dialdehyde, or epoxidized linseed oil.

22. The food casing as claimed in claim 8, wherein the proportion of crosslinking agent(s) is from 3 to 16% by weight, based on the total weight of collagen fibrils and gelatin.

23. The food casing as claimed in claim 8, wherein the proportion of crosslinking agent(s) is from 5 to 10% by weight, based on the total weight of collagen fibrils and gelatin.

24. The food casing as claimed in claim 10, wherein the coating has a coating weight of from 150 to 7000 mg/m².

25. The food casing as claimed in claim 10, wherein the coating has a coating weight of from 250 to 5000 mg/m².

26. The food casing as claimed in claim 11, wherein the plasticizing synthetic polymer dispersion is an acrylate dispersion, synthetic rubber dispersion, or polystyrene dispersion.

27. The food casing as claimed in claim 12, wherein the secondary plasticizer is glycerol.

28. The process as claimed in claim 15, wherein the secondary plasticizer is glycerol.

29. Synthetic sausage casing as claimed in claim 18, wherein said synthetic sausage casing encases raw sausage.
